(19) United States
(12) Patent Application Publication
(10) Pub. No.: US 2017/0047810 A1
(43) Pub. Date: Feb. 16, 2017

(54) PORTABLE APPARATUS FOR GENERATING ELECTRICAL ENERGY

(71) Applicant: DECIWATT LIMITED, London (GB)

(72) Inventors: Martin Philip RIDDIFORD, London (GB); James William REEVES, Twyford, Berkshire (GB); T. A. POLAK, London (GB)

(21) Appl. No.: 15/306,912

(22) PCT Filed: Apr. 28, 2015
(86) PCT No.: PCT/GB2015/051241

§ 371 Date: Oct. 26, 2016

(30) Foreign Application Priority Data
Apr. 28, 2014 (GB) 1407447.0

(51) Int. Cl. H02K 7/02; F03G 3/00; H02K 7/108; H02K 7/116; H02K 7/10

(52) U.S. Cl. CPC H02K 7/025; H02K 7/116; H02K 7/1004; H02K 7/108; F03G 3/00

(57) ABSTRACT

A portable apparatus for generating electrical energy is provided comprising: an electrical energy-generating device for generating electricity in response to input mechanical action; a gravity powered drive for supplying the said mechanical action to the electricity-generating device by the descent of a suspended mass under the force of gravity; and a re-energising mechanism adapted to cause the gravity powered drive to operate whilst the mass is being raised.

### FIELD OF THE INVENTION

The present invention relates to a portable apparatus for generating electrical energy through the descent of a mass under the force of gravity.

### BACKGROUND TO THE INVENTION

The GravityLight™ product, available from Deciwatt Ltd (Company No. 08589358) and described in WO2011/045606 and WO2014/195681, is a portable electrical energy generating apparatus designed to provide lighting to customers who do not have access to mains electricity. In particular, the GravityLight™ was conceived to replace the use of harmful kerosene lamps in developing countries, where the low cost of such a device is critical to its acceptance and uptake. The device is operated by a user lifting a mass (either by grasping the mass or pulling on a counterweight) and then releasing the mass, which then powers a generator on its descent, creating sufficient electrical energy to provide a light, or power electronic devices such as a radio, or charge batteries etc. It has drawbacks when compared with other lighting and power systems however; for example it does not give continuous power. When the mass is lifted, the drive strap (a sprocket belt) is re-wound in the opposite direction via a ratchet system, leading to the generator being decoupled and no power generated temporarily. The user may therefore be required to lift the heavy mass safely (past the counter-weight) in total darkness. This only happens for a few seconds every twenty minutes or so, and has been generally accepted by users as an inevitable feature of this new type of free-to-run lighting.

### SUMMARY OF THE INVENTION

In accordance with a first aspect of the invention, there is provided a portable apparatus for generating electrical energy, the apparatus comprising:
an electrical energy-generating device for generating electricity in response to input mechanical action;
a gravity powered drive for supplying the said mechanical action to the electricity-generating device by the descent of a suspended mass under the force of gravity; and
a re-energising mechanism adapted to enable the gravity powered drive to operate whilst the mass is being raised.

An apparatus is thus provided which overcomes the cited deficiencies in the prior art by outputting continuous power regardless of whether the mass is descending under the force of gravity or is being raised (with respect to the ground) by a user. This continuous system opens up different patterns of use for users of the device. When operating the prior art GravityLight™, users do not generally lift the mass before it has hit the floor as the light/power will go out during the rewind procedure and this increases the frequency of re-energising operations. The system described herein however allows users to regularly “top-up” by part lifting the mass for example every time they pass it without the loss of light/power. This regime also creates more useful continuous power for a radio or charging batteries etc.

Various methods of enabling this device to run continuously have been contemplated by the applicant. One such method is to use the generator to charge batteries which can then power the light during the lifting period. Aside from being relatively expensive to provide re-chargeable batteries (and the appropriate circuitry), this method has the added disadvantage that up to half of the energy generated is lost through a battery charge and discharge cycle. Another possible way to achieve continuous running is to use a spring to store a sufficient amount of energy to power the light for the period of lifting (e.g. around five seconds). This adds complexity and cost to the system however. Furthermore it provides an extra failure point in the apparatus and puts pressure on the user to lift the mass quickly. Yet another approach is to use two GravityLight™ devices together, so that one is still working when the mass of the other is being lifted. This has some disadvantages, however, in that unless all attached devices, such as peripheral task lights or radios, are also duplicated to take over when one of the GravityLight™ devices reaches the end of a drop cycle, which increases costs, then additional electrical circuitry will be required to cope with the back flow currents that must be avoided where the outputs of two GravityLight™ generators are electrically connected, which reduces efficiency and/or increases cost. An improvement would then be to combine a single generator with two separate masses and drives to reduce some of the cost. However this approach has disadvantages in that it either requires the mount point to support double the mass, or it reduces the power output to only half when only one of the weights is driving the system and the other is either waiting to be, or is being lifted. It also adds size due to the clearance required to allow two masses to comfortably pass each other.

These problems are solved herein however due to the provision of a re-energising mechanism adapted to enable the gravity powered drive to operate whilst the mass is being raised. The re-energising mechanism may cause the gravity powered drive to be subjected to the gravitational force of the mass whilst the mass is being raised during a re-energising procedure. For example, the mass may be suspended from a loop and raised by shortening one side of said loop. The mass can then continue to apply mechanical action/force to the gravity powered drive through its weight via continuous progression of the other side of said loop, even though the mass itself is being lifted. This re-energising procedure (or re-energising action) involves inputting mechanical work to the apparatus which converts said work into a store of gravitational potential energy in the form of an elevated mass, which is then gradually converted to kinetic energy that drives the electrical energy-generating device. This has the advantage that unlike other sources (such as kerosene or solar energy), gravitational potential energy can be freely generated by all and at all times of day. The device can thus be produced for minimum cost and then run without on-going costs. Furthermore unlike rechargeable batteries (for example), the efficiency of the apparatus will not significantly worsen over time.

In order to supply mechanical action to the electricity-generating device it is particularly advantageous wherein the gravity powered drive comprises a drive mechanism and an elongate flexible member, wherein said elongate flexible member is coupled with the drive mechanism and the mass when in use so as to provide the gravitational force for operation. The flexible elongate member is preferably a sprocket belt, a chain, a strap or a cord. An example of a suitable cord is a beaded cord. The drive mechanism may comprise a sprocket, gear, toothed wheel, toothless wheel or hub, for example. The elongate flexible member may be a closed endless loop. To enable re-energising or “re-charging” of the device, the elongate flexible member of the gravity drive is preferably further coupled with the re-energising mechanism. The elongate flexible member advantageously remains taut between the mass and the gravity drive mechanism during the re-energising procedure. This allows drive from the weight of the mass to be transferred to the electrical-generating device whilst the mass is being elevated. Preferably still the elongate flexible member remains taut between the mass and the re-energising mechanism during the re-energising procedure.

A further benefit is provided wherein each of the re-energising mechanism and the drive mechanism are coupled in series simultaneously at different locations along the elongate flexible member. Where this is the case, the apparatus is preferably configured such that during a re-energising procedure, the length of elongate flexible member between the said different locations is changed. Preferably still, during a re-energising procedure, part of the said length of the elongate flexible member is grasped by a user and a force applied to the elongate flexible member so as to change the said length and lift the mass.

Advantageously, the elongate flexible member forms a first loop and a second loop, the said mass being suspended from the first loop only, wherein said mass is raised by pulling on the second loop so as to increase the length of said second loop and decrease the length of the first loop. The first and second loops form respective hanging portions of the same elongate flexible member. This has the particular advantage over the prior art that the mass can be lifted to a height in excess of what is naturally within reach of the user and so, the mass can descend for longer, allowing for power to be generated for longer durations before it is necessary to re-energise the system. Furthermore, there is less chance of back strain occurring if a user is pulling down on the elongate flexible member, in order to elevate a mass, rather than directly lifting the mass through grasping and raising the mass itself.

The re-energising mechanism is preferably provided with a re-energising member. This re-energising member may be in the form of an elongate flexible member, such as a sprocket belt, a chain, a strap or a cord and is typically provided as an endless loop. Unlike the elongate flexible member of the gravity powered drive, the length of the elongate flexible member of the re-energising mechanism, that may be pulled on to raise the mass, typically remains constant at all times. This enables the user to grasp the re-energising member to rotate the re-energising mechanism so as to hoist the mass, regardless of the distance by which the mass has descended. In some implementations the re-energising member itself may further comprise a peddle system or a treadle. Furthermore, the re-energising member may be provided as a recoil member. Alternatively still the re-energising mechanism may comprise a one-way ratchet and/or a crank handle.

A clear benefit is provided wherein the re-energising mechanism is arranged to provide a mechanical advantage with respect to the force provided by the descending mass such that the force needed to lift the mass is less than the gravitational force provided by the mass. This enables a user to lift a mass with greater ease (benefiting the elderly, children and those with disabilities) and to potentially lift a mass which is heavier than they otherwise would be able to lift by grasping the mass itself.

Currently, if using the prior art GravityLight™ device users generally prefer to grasp and lift the mass itself rather than pull on the counter-weight. However, by providing the above arrangement, the force required to lift the mass can advantageously be reduced (e.g. through gearing). Once a comfortable pull force has been established, a heavier mass can be lifted, albeit more slowly, by changing the gearing, like in a hoist system. In order to allow the system to rotate in one direction only, the re-energising mechanism may preferably comprise a ratcheted sprocket.

Alternatively, or in addition to this, the re-energising mechanism preferably comprises a wrap clutch, said wrap clutch comprising a rewind sprocket having a central mandrel that is coaxial therewith and a coil spring that is wound about the mandrel. The coil spring is configured to apply a gripping force to the mandrel when a torque, having a magnitude within a predetermined operational range of torque (this range including “normal” use in generating electricity), is applied to the rewind sprocket in a first direction, the said gripping force being sufficient to prevent rotation of the rewind sprocket in said first direction. The coil spring is further configured to be decoupled from the mandrel, during a re-energising procedure, when a torque is applied to the rewind sprocket in a second direction opposite to the first direction, so as to allow rotation of the rewind sprocket in the second direction. This has the benefit that unlike ratchets, wrap clutches do not generate a clicking noise when rotated.

In the case of the prior art GravityLight™, the system is directly subject to the full force of the load the user is able, or willing, to lift. It is possible to envisage this user-limited weight being in considerable excess of the system's rated maximum, leading to system failure as a result of stripped gear teeth. Various solutions are provided herein for protecting the apparatus from this damage which can be used independently or in combination as desired. This overload protection mechanisms described below operate generally in accordance with the torque applied to the gears by the suspended mass, rather than the total downward force on the apparatus at the hanging point, as per WO2014/195681. This has specific benefits for the continuous power development described herein, as will be discussed.

An advantage is hence provided wherein a first part of the coil spring is configured to be displaced by a predetermined amount in accordance with a first wrap overload condition in which the torque applied to the rewind sprocket in the first direction lies within the said predetermined operational range and exceeds a first wrap torque threshold. In this case the wrap clutch further comprises a wrap torque sensor in the form of a first switch. The said first switch is operative to provide an electrical change of state in response to said displacement of the first part of the coil spring when the first wrap overload condition has been met. Preferably the wrap torque sensor further comprises a warning device (such as an LED or audible warning) configured to indicate to a user when the first wrap overload condition has been met in response to the electrical change of state provided by the first switch.

Preferably still, the wrap clutch further comprises a wrap overload protector operatively configured to prevent the gripping force from exceeding a predetermined magnitude, said predetermined magnitude of gripping force corresponding to an upper limit of said operational range of torque according to a second wrap overload condition. This is operative such that, when the torque applied to the rewind sprocket in the first direction exceeds the upper limit of the operational range of torque, the mandrel is allowed to rotate relative to the coil spring thereby causing a controlled descent of the mass. To effect this, the wrap overload protector preferably includes a projection from the coil spring and a stop, the projection being adapted to impact against the stop due to rotation of the mandrel afforded by a known amount of elastic spring deflection, whereby the stop prevents further increase in frictional grip so as to prevent the gripping force from exceeding the predetermined magnitude. In particular this protects the apparatus from damage due to use of an excessive mass (this including the effect of children using the apparatus as a swing) and provides the safety advantage of lowering the excessive mass to the ground in a controlled manner.

Alternatively, or in addition to the solutions provided above, a further benefit may be achieved wherein the apparatus further comprises a slip clutch adapted to prevent the mass from being raised when the re-energising mechanism is subjected to a hoisting force in excess of a predetermined threshold. In doing so, the slip clutch may protect the gravity powered drive from the weight of the suspended mass. This also removes the potential overload hazard caused by a user applying too much mass in order to gain greater power output. The weight of the mass will typically not change once it has been hoisted and so, by applying an overload protection mechanism to the re-energising mechanism in the form of a slip clutch, it is possible to get an indication of whether the weight exceeds a safe maximum from whether the force required (and applied) to raise the mass exceeds a predetermined threshold, for example by providing an audible click in response to the force applied by the user.

Another advantageous arrangement for reducing the likelihood of damage occurring to the system due it being overloaded is provided wherein the apparatus is configured such that the gravity powered drive and electrical energy-generating device may rotate at least partially with respect to each other about a common axis, the apparatus in this case further comprising a torque sensing mechanism. The said torque sensing mechanism comprises a flexible member configured to resist relative rotation between the gravity powered drive and the electrical energy-generating device wherein the flexible member prevents any said rotation if a torque applied to the gravity powered drive is below a first torque threshold and, wherein at a first torque overload condition, where the torque applied to the gravity powered drive exceeds the first torque threshold, the resistance provided by the flexible member is partially overcome so as to allow partial rotation between the gravity powered drive and the electrical energy-generating device. The torque sensing mechanism includes a second switch operative to provide an electrical change of state when the first torque overload condition has been met, in response to said partial rotation. This may be provided in addition to or instead of the wrap torque sensor.

The first torque overload condition and/or the first wrap overload condition may be met when the weight of the suspended mass is marginally beyond the predetermined operating range for the system (for example between 100-110% the predetermined maximum operating torque). The first torque threshold and the first wrap torque threshold are typically functions of the maximum reliable operating torque and may include a safety factor to account for product variation, inaccuracies etc. These thresholds may be the value at which the designer is happy for the system to run and still achieve the required service life in an acceptable percentage of cases. This must be the case, as it must be accepted that the system could be driven by a mass only just below the first torque/wrap threshold (or practically equal to it) without actuating the respective switch.

Preferably still, the torque sensing mechanism further comprises a warning device configured to indicate to a user when the first torque overload condition has been met in response to the electrical change of state provided by the second switch. The switch and warning device may hence alert a user to this overload situation, whilst the apparatus continues to generate electricity, and before excessive wear to the system is incurred, which may eventually lead to a system failure. In the event that both the wrap torque sensor and the torque sensing mechanism are provided, the warning device may for example only be triggered if both the first and second switches are actuated.

The apparatus may advantageously be configured such that when the gravity powered drive and electrical energy-generating device may rotate with respect to each other about a common axis, the apparatus further comprises a torque overload protection mechanism; wherein said torque overload protection mechanism is configured to allow full rotation between the gravity powered drive and the electrical energy-generating device only if the gravity powered drive is subjected to a torque in excess of a second torque threshold according to a second torque overload condition.

Increasing the weight of the suspended mass increases the mechanical resistance to rotation provided by the electrical-energy generating device. This resistance acts on the gravity powered drive and arises, for example, from inertia, back EMF induced by the electrical energy-generating device, the windage and other high-speed related losses cause rising resistance to rotation as the speed increases. This resistance can cause damage to the gravity powered drive, for example by stripping gear teeth or breaking the elongate flexible member. Both of these scenarios lead to functional failure and a sudden and uncontrolled descent of the weight which could cause injury and would certainly cause alarm. The torque overload protection mechanism is therefore preferably configured to decouple the gravity powered drive from the electrical energy-generating device during the second torque overload condition, so as to allow the mass to descend without providing input mechanical action to the electrical energy-generating device.

The torque corresponding to the second torque threshold is preferably in excess of the torque corresponding to the first torque threshold. The first torque threshold can typically afford to be closer to the known reliable operating limit than the second torque threshold can be, in relation to the safe operating limit, assuming the consequences of sudden failure are worse than an excessive degradation of function over time. In this particular instance, with a suspended mass in a domestic setting, protection against sudden failure is a primary concern. The second torque threshold may hence be chosen to be around 25% of the known instantaneous failure value, for example. The larger the margin of safety that is required, the greater the increase in product cost, due to the requirement for stronger and/or additional material. The first torque threshold may be up to 95% of the ‘rated’ or ‘design’ torque, but only if the accuracy by which the load is determined, or sensed, is high. At 95%, for example, production cost reductions are close to maximised, assuming unwieldy quality control requirements can be avoided. It is advantageous then, in all cases, to have the most accurate sense of the loads applied to the system (as it is possible to economically obtain) in order to reduce the requirement for engineering redundancy and to reduce the instances of product failure, reductions in both having positive effects on economy in general. Achieving accurate and reliable sensing, by the simplest and most economic means, is therefore of great benefit to the design.

In an advantageous arrangement, said gravity powered drive comprises an annular gear, a plurality of planetary gears and a mount plate, wherein said planetary gears are mounted to the mount plate and configured to engage with the annular gear; wherein said electrical energy-generating device comprises a gear train having a sun gear positioned at an upstream end of the gear train and an electrical generator positioned at a downstream end of the gear train, wherein the sun gear is configured to engage with the planetary gears. This enables a high step up ratio to be achieved so that a suspended mass can slowly descend and provide a useful power output. Preferably still, in examples where rotation between the gravity powered drive and the electrical energy-generating device is desired, this rotation may be effected by the mount plate being configured to rotate about the sun gear. In such examples which utilise a flexible member, typically the flexible member is configured to provide a resistance force so as to resist relative rotation between the mount plate and the electrical energy-generating device in response to a torque applied to the mount plate by the planetary gears mounted thereon; wherein the resistive force provided by the flexible member is such that: below the first torque threshold applied to the mount plate, the flexible member engages with the mount plate so as to limit rotation of the mount plate relative to the electrical energy-generating device; above the first torque threshold but below the second torque threshold applied to the mount plate, the flexible member is deflected by the mount plate so as to allow a further rotation of the mount plate about the electrical energy-generating device; and above the second torque threshold, the flexible member is disengaged so as to allow a free rotation of the mount plate about the electrical energy-generating device.

The use of a gravity powered drive with the annular gear, planetary gears and mount plate as discussed above provides an unexpectedly advantageous arrangement for providing an effective re-energising function. In this case the annular gear is configured to rotate in a first direction when the gravity powered drive is driven by the suspended mass; the re-energising mechanism is configured to prevent rotation of the mount plate in the first direction and to allow rotation of the mount plate in a second direction opposite to the first direction in response to a mechanical input provided by a user during a re-energising procedure; and said rotation of the mount plate in the second direction causes the annular gear to rotate in the second direction, thereby raising the mass. This may be achieved in a number of ways in practice, for example by coupling the mount plate to a wrap clutch or ratchet and to a re-energising member. This arrangement has advantages both in terms of cost reduction and in increasing the overall efficiency and product life of the apparatus.

Another hazard to the system exists where additional weight is applied after the mass is hoisted. Additional mass could be added by hooking extra weights on to the main mass, but most commonly, this ‘in-use’ additional weight has been known to be applied by young children playing with the GravityLight™ when unsupervised: using the load mass as a swing seat for example. The looped elongate flexible member, as described above, has the inherent advantage that it divides any load applied to the gravity powered drive. As a result, in the case where the apparatus is being played with as a swing, the load applied to the gear teeth is half the hoisted weight, plus half the weight of a child (in the case of a child sitting astride the weight). If the maximum specified load mass to be hoisted is closely equivalent to the mass of a child (around 25 kg to 30 kg for example), then the load on the system is temporarily doubled by the child sitting on the bag. The system can then be specified to work within safe gear wear load limits, with a breaking force limit set in excess of the load mass plus half the mass of a small child i.e. in excess of twice the design load. Such an arrangement can remove the requirement for overload sensing switches, systems and circuitry entirely, as described in WO2014/195681. This can offer reductions in cost, complexity and removes several points of potential failure. An alternative, more sophisticated, rewind method is to use a recoil pull cord. This arrangement can be exchanged for the above to enable more pull force to be applied by virtue of its compatibility with a more ergonomic and comfortable handle (e.g. a ‘T’ handle)—such as when heavier weights are employed.

The electrical energy-generating device preferably comprises an electrical generator selected from the group comprising an alternator, a direct current motor or a dynamo. In order to output electrical energy over a long duration, the electrical energy-generating device preferably comprises a gear train for converting a relatively low speed input from the gravity powered drive to a relatively high speed output at the electrical energy-generating device. These gears may be toothed, smooth or a combination of both. For example, a smooth toothless gear wheel may be provided on the most downstream end coupled with a conical member of the generator drive shaft to enable an adjustable power output through varying the point of contact between the perimeter of the wheel and the conical member. Alternatively, a rubber belt may be coupled to a most downstream gear wheel and a motor-shaft pulley so as to provide a fixed (non-adjustable) gear ratio, but a simpler, more reliable coupling. Adjustable gearing may then be provided upstream. Toothless wheels have the added advantage that a relatively low noise is generated through the gear interaction.

The electrical energy-generating device and gravity powered drive are preferably provided as a unit, the gravity powered drive including a flexible sprocket belt or analogous member to one end of which is coupled the mass when in use so as to provide the force for operation of the apparatus.

In accordance with a second aspect of the invention, there is provided a kit comprising:
a portable apparatus according to the first aspect of the invention;
an elongate flexible member to form part of the gravity powered drive; and
a weight bag for attachment to the elongate flexible member.

### BRIEF DESCRIPTION OF THE DRAWINGS

Some examples of a portable apparatus for generating electrical energy in accordance with the invention are now described, in which:

FIG. 1 is an illustration of a first example of the apparatus;

FIG. 2 is an illustration of a second example of the apparatus;

FIG. 3 is an illustration of a third example of the apparatus;

FIG. 4 is an illustration of a prior art apparatus in use;

FIG. 5 is an illustration of an example of the apparatus in use;

FIG. 6 is an illustration of two further examples of the apparatus according to the invention in use;

FIG. 7 is a front view illustration of an example gear system during normal use;

FIG. 8 is a side view illustration of the example gear system;

FIG. 9 is an illustration of a back cross-sectional view of the example gear system taken through the A-A plane;

FIG. 10 is an illustration of a front cross-sectional view of the example gear system taken through the B-B plane; and

FIG. 11 is a front view illustration of an example of the gear system during an overload condition;

FIG. 12 is an illustration of an example of a re-energising mechanism comprising a wrap clutch;

FIG. 13 is a an illustration of an example of a re-energising mechanism comprising a wrap clutch during a re-energising procedure;

FIG. 14 is an illustration of an example of a re-energising mechanism comprising a wrap clutch during normal use, below a first wrap torque threshold; and

FIG. 15 is an illustration of an example of a re-energising mechanism comprising a wrap clutch during a first wrap overload condition;

FIG. 16 is an illustration of an example of a re-energising mechanism comprising a wrap clutch during a second wrap overload condition; and

FIG. 17 is an illustration of an example of an apparatus comprising a re-energising mechanism configured to allow rotation of the mount plate during a re-energising procedure.

### DETAILED DESCRIPTION

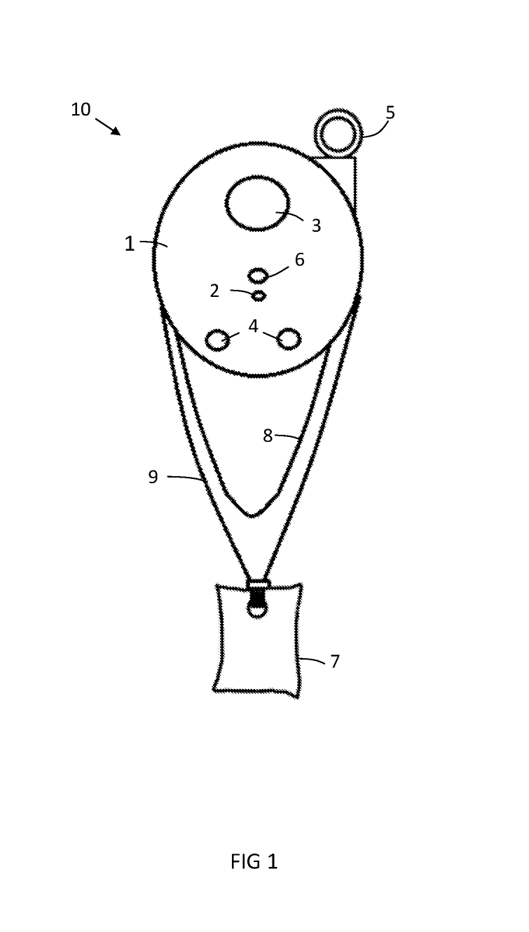

FIG. 1 is a schematic representation of a first example of the apparatus. This takes the form of a system 10 provided in a three-part kit form. The system has a housing 1, a mass 7 and an elongate flexible member. The elongate flexible member is threaded through a path within the housing (generator unit) 1 and extends out of the housing 1 to expose a weight chain 9 and a pull chain 8 (or re-energising member). The weight chain 9 and the pull chain 8 are thus two different hanging portions (or loops) of the same closed endless loop formed from the elongate flexible member. The mass 7 is coupled to the weight chain 9 only for providing the gravitational force for operation of the apparatus (i.e. for generating electricity). The weight chain 9 and the pull chain 8 could be considered as a first loop and a second loop respectively. One side of the second loop 8 is pulled downward by a user so as to lengthen the second loop 8 and meanwhile shorten the length of first loop 9 correspondingly so as to lift the mass 7. The elongate flexible member may, for example, be a sprocket belt made of strong and durable plastics material such as polypropylene provided with a plurality of regularly spaced rectangular apertures or a bead-cord for engagement with sprockets (to be described) within the housing 1.

The housing 1 takes a generally ellipsoidal form in two dimensions and is formed from two parts (generally forming front and rear “halves” of the housing 1, the front half being illustrated in FIG. 1) manufactured from a rugged plastics material. On the front face of the front half of the housing is located a power control dial 3 which may be rotated manually by a user so as to control the electrical power output. A high luminosity LED (light emitting diode) 6 is located approximately centrally and below the power control dial 3 in a region of moulding of the housing material (not shown) so as to direct the light from the LED 6 in a wide cone directly outwardly and downwardly away from the housing 1. Alternatively, the LED 6 may be oriented so as to direct the emitted light onto the housing such that the reflected light from the housing illuminates the room at a reduced glare. Below the LED 6 is located an ON/OFF switch 2. Adjacent the lower periphery of the front face and straddling a vertical centreline of the housing 1 are positioned two power terminals 4 providing positive and negative polarity connectors for the supply of electrical direct current to a device at the choosing of the user. Alternatively this interface can be configured to provide any number of sockets for multiple or simultaneous connections, either functionally similar or differentiated by suitability for the requirements of a specific type of peripheral, and afforded by various types of connector offering either simple direct connection or configured to initiate changes of state in the system on insertion of an appropriate plug. For example, a particular socket may provide connection to the generator via a path to include additional intermediate electronic components, or simply to provide a choice of connections that are either in series with, or in parallel with, the on-board LED and/or other peripherals present in the overall system at a given time, Alternatively, an alternating current output could be provided from any generic power connector.

When no peripheral device(s) are connected to the terminals 4, the electrical power generated by the device is provided to the LED 6. The power dissipation in the LED 6 is controllable by the user by suitable rotational positioning of the dial 3 (which in turn changes gearing 13 provided within the housing 1). For example rotating the dial 3 fully in one direction maximises the power output causing the mass 7 to descend at its maximum operational rate. This generates the highest level of illumination (useful for lighting a dwelling or other structure to enable routine tasks for the inhabitants) from the LED 6 although the operational time is reduced due to the higher energy consumption. Lower levels of illumination may be achieved by rotating the dial 3 in the opposite direction so as to effect a longer duration of lighting, as might be needed for a “night light” for example. In the event that a device or other electrical circuitry is connected to the terminals 4, the power is provided to that device or circuitry via the terminals 4. A simple switch may be used to provide power to one or each of the terminals 4 and LED 6, or a switching action may be automatically actuated upon insertion of a plug into a socket rather than manually controlled by the actuation of a switch made available externally to the user.

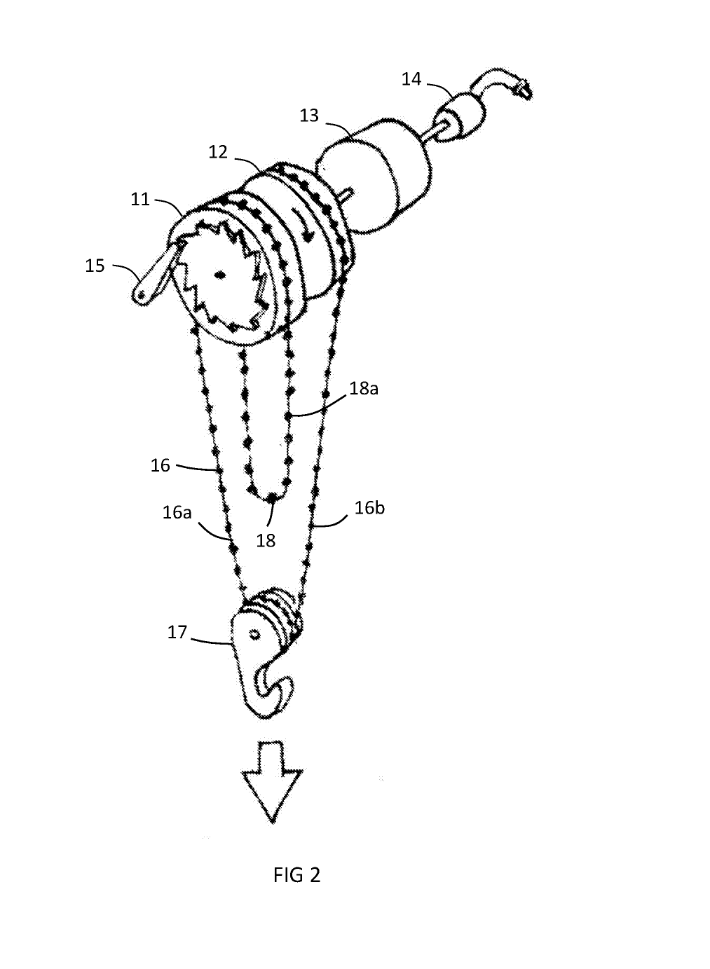

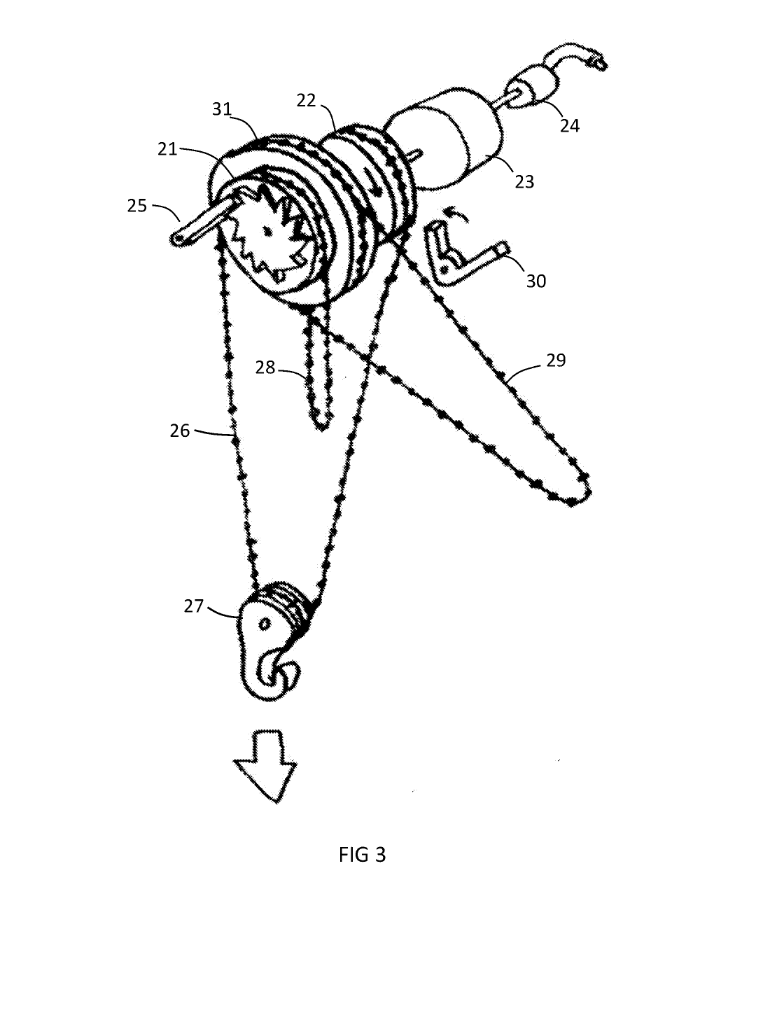

In general, the apparatus is portable in the sense that is lightweight (e.g. less than 20 kilograms) and can be readily carried as a unit in the hands of a user. As such it may be mounted and dismounted by a user to an elevated position, without the need for mechanical assistance to elevate or otherwise move the apparatus. In this example the apparatus is designed to be suspended from an eyelet 5 which allows it to be placed securely upon a suitable hook or lashed to a beam or other elevated point using a thin rope or tie for example. The mass 7 comprises a hook 17 (shown in FIGS. 2 and 3) and a strong bag being open at one end and having an eyelet positioned centrally adjacent the open end for attachment to the weight chain 9 by the hook 17. The bag is filled with a readily available material when in use, for example, soil, sand or stones. The volume of the bag is designed such that, when full the bag has a mass of about 12 kg (e.g. plus or minus ten per cent). The mass 7 is coupled to the end of the chain 9 which hangs directly below the eyelet 5. The hook 17 is configured to engage with the weight chain 16 so as to apply the weight of the mass 7 to the chain 9.

The function of the pull chain 8 is to allow the user to elevate the mass 7 during a re-energising procedure by pulling down on the chain 8 (rather than by grasping and lifting the mass itself, which in this configuration, given the absence of any counter-weight to draw the elongate flexible member back through the system, would provide no re-energising outcome). During this procedure the pull chain 8 is drawn through the housing 1 and in doing so increases in length whilst the weight chain 9 decreases by the same length (since they are formed from the same closed loop). Unlike the prior art, the mass is not decoupled from the electrical energy-generating device during the re-energising procedure (the weight chain 9 remains taut between the drive mechanism 12 and the mass 7). The mass 7 applies approximately the same force to the electrical energy-generating device whilst it is being raised as whilst it is descending and so the apparatus 10 will continue to output continuous power throughout. In reality a small increase in force occurs during hoisting equal to the mass plus the additional force that is being exerted to accelerate it, but the amount of variation is not made evident to the user by a significant change in output power or light brightness.

FIG. 2 is a schematic illustration of second example of the apparatus with the housing 1 not shown. An elongate flexible member, formed here from a loop of plastic cord having regularly spaced plastic beads, engages with two sprockets provided inside the housing; a rewind sprocket 11 and a drive mechanism 12. As in the previous example, the elongate flexible member forms two loops or ‘chains’ that hang from the apparatus—a weight chain 16 and a pull chain 18. The re-wind sprocket 11 and the drive mechanism 12 are coupled in series simultaneously at different locations along the elongate flexible member. Furthermore, a mass 17 (shown here as a hook, without a weight bag attached) is suspended from a weight chain 16 only. The elongate flexible member is not fixed to the mass 17 and is configured to move through the hook when in use e.g. by rotating or winding on a wheel or sprocket provided on the hook.

The drive mechanism 12 and the weight chain 16 collectively form a gravity powered drive for supplying mechanical action, from the descent of the suspended mass 17, to an electrical energy-generating device. The mass 17 exerts a downward force on the weight chain 16 due to its weight, as shown by the downward arrow. The drive portion 16b of the chain 16 couples this weight to the drive mechanism 12. This force causes the drive mechanism 12 to rotate in a clockwise direction as shown. The electrical energy-generating device (formed from a gear system 13 and an electrical generator 14) then converts this rotational kinetic energy to electrical energy, which is then supplied to the LED 6 and power terminals 4. The generator may be an alternator, a direct current motor or a dynamo.

The gear system 13 (shown schematically only) may comprise any system of smooth gears (including pulleys) or toothed gears for converting a relatively low speed input from the drive mechanism 12 to a relatively high speed output at the generator 14. For example, the ratio of the sprocket rotation to the generator rotation may be about 1:750 (e.g. plus or minus ten per cent). This figure can be scaled considerably however depending on the weight used, the desired rate of descent and the sprocket radius, the speed constant of the chosen generator and the desired operational voltage. As previously described, the gear system 13 may be adjustable in response to a user controlling the power control dial 3 so as to modulate the power supplied to the generator 14. There are design limitations placed upon the mechanism within the housing 1 and in particular the gear train 13. For example it is desirable that the gear train operates quietly, is not subject to high rates of wear and is of low cost. Cost is a critical factor in producing a system which may be used by people in undeveloped areas of the world (such as parts of Asia and Africa) who survive typically on very low incomes.

The rewind sprocket 11 is configured to rotate in one direction only (here clockwise) due to the interaction between a pawl 15 and a ratchet provided on a flat, circular outer surface of the rewind sprocket 11. The elongate flexible member thus always moves through the system in the same direction, as winding or rewinding does not reverse its direction. The sprocket 11 and pawl 15 form a re-energising mechanism (in the form of a ratcheted sprocket) enabling the gravity powered drive to operate whilst the mass 17 is being raised. As before, the mass 17 is lifted by a user grasping and pulling down on a particular length of the pull chain 18 so as to wind the rewind sprocket 11 against the pawl 15. This action increases the length of the loop of the pull chain 18 and decreases the length of the loop of the weight chain 16 (by retracting the loaded portion 16a of the weight chain 16 which extends between the mass 17 and the rewind sprocket 11) correspondingly, thus raising the mass 17. Once the mass has been raised and the chain 18 is released, it will slowly descend on the weight chain 16, causing the weight chain 16 to lengthen as the pull chain 18 shortens. It is advantageous therefore to ensure that the elongate flexible member is sufficiently long that the pull chain 18 is always exposed (at least to some extent), even if the mass 17 is touching the ground.

In its simplest guise, as described above, this arrangement achieves several advantages over the prior art. It will give continuous power as long as the mass 17 is not allowed to hit the floor, and if it does, power is generated immediately when a user starts to rewind it, not when rewinding is finished. The user now pulls a chain 18 with only half the force required to lift the weight, due to the mechanical advantage afforded by the pulley arrangement. Furthermore, the pawl 15 is only loaded with half the force of the weight, reducing the strain on the gearing.

A further improvement to the above is to have the possibility of more than a 2:1 mechanical advantage, enabling a heavier mass to be used. Adding further loops and pulleys can do this, like in a hoist system. However, in a third example shown by FIG. 3 this is achieved by fixing a third ‘charging’ sprocket 31 to the side of the ratcheted rewind sprocket 21 so that the two sprockets 21, 31 rotate about a common rotational axis. The charging sprocket 31 has a separate looped elongate member 29 referred to here as the ‘hoisting chain’ 29 (or re-energising member) coupled around it/enmeshed with it. As in the previous example, another elongate member is threaded through a path between the drive mechanism 22 and the rewind sprocket 21 so as to form a weight chain 26 and an excess chain 28 (previously equivalent to the pull chain 18). The charging sprocket 31 has a larger diameter than the rewind sprocket 21 so that a mechanical advantage is provided if the user pulls down on the hoisting chain 29, rather than the excess chain 28, to lift the mass 27. The hoisting chain 29 is a separate closed endless loop. A fixed portion of this chain 29 is exposed from the housing 1 at all times for a user to hoist the weight 17 by pulling down on chain 29. This is more convenient for the user than a length that varies (as per the previous example). The hoisting chain 29 can be differentiated from the other elongate flexible member by colour, shape, material, pitch etc. to aid visibility, increase comfort in the hand, and promote ease of use.

An additional benefit can be gained if the charging sprocket 31, rather than being permanently attached to the rewind sprocket 21, is coupled to the rewind sprocket 21 via any of several ‘slip clutch’ mechanisms. With this arrangement the hoisting chain 29 can be load limited and set to ‘slip’ when the load mass 27 to be hoisted is heavier than a pre-determined upper load limit. The charging sprocket ‘clutch’ can give the user instant feedback by making a loud audible ‘clicking’ to indicate overload when too much force is being applied i.e. when the mass 27 to be lifted is too heavy. Such overload clutch mechanisms can be employed to set an upper limit and allow the mass 27 to fall fast in the case of overload, but with a mass 27 in excess of the clutch's maximum, these mechanisms have the disadvantage of tending to run away once they are overcome, allowing the suspended load mass 27 to fall suddenly without significant deceleration. Although this is a very effective method of protecting the mechanism and the weight chain from damage through overload, and may be desirable in some instances, the suddenly falling load mass can be a hazard and can be alarming. By employing the clutch effectively between the user's input effort and the mass 27 to be hoisted, no such runaway outcome occurs. The user will stop hoisting, as they are given audible feedback from the system before the mass 27 is raised that the load is too heavy, and their effort fails to raise the mass from the floor even if they continue to try and hoist. The user will then need to adjust the load to be within limits, and resume hoisting. As the mass 27 is lifted by way of the re-energising member 29, the user is prevented from applying a load that is too high and it will not be possible to raise an oversized mass 27 from the floor.

A useful extra feature is to be able to pause descent of the weight and turn off the light, so that it can be switched back on at a later time without wasting the effort that was used to charge the device, and without needing to input further effort in order to use it again. The new arrangement enables this to happen straightforwardly. As illustrated in FIG. 3 a mechanical switch 30, in the form of a wedge, can be positioned such that when engaged it prevents the drive mechanism 22 (or any of the other gears) from rotating. The mechanical switch 30 is further mechanically coupled with the ON/OFF switch 2 to enable a user to pause the apparatus from outside the housing 1. By engaging the switch 30, the load is removed from the gearbox 23, enabling the system to be left safely in this stationary state indefinitely without power being generated by the generator 24.

The force of the weight could tend to jam the mechanical switch 30 however and a considerable force may be required to disengage it. This can be overcome with careful design incorporating a large mechanical advantage to make it easy to use. However, if the user instead pulls on the hoisting chain 29 (or alternatively the pull or excess chain 28), rotation of the rewind sprocket 21 and charging sprocket 31 can engage with the wedge and flip it back out, thus releasing the drive mechanism 22 and turning the light back on. It is an intuitive action to pull on the chain 29 to create light, no matter whether the mass 27 is on the ground or if it has been locked. Alternatively a spring push-push mechanism may be used that latches the switch 30 in place until the next push. This locking feature 30 opens up many more uses for the apparatus, such as a shed or toilet light, where instant light is expected. Good practice would be to rewind it for the next time.

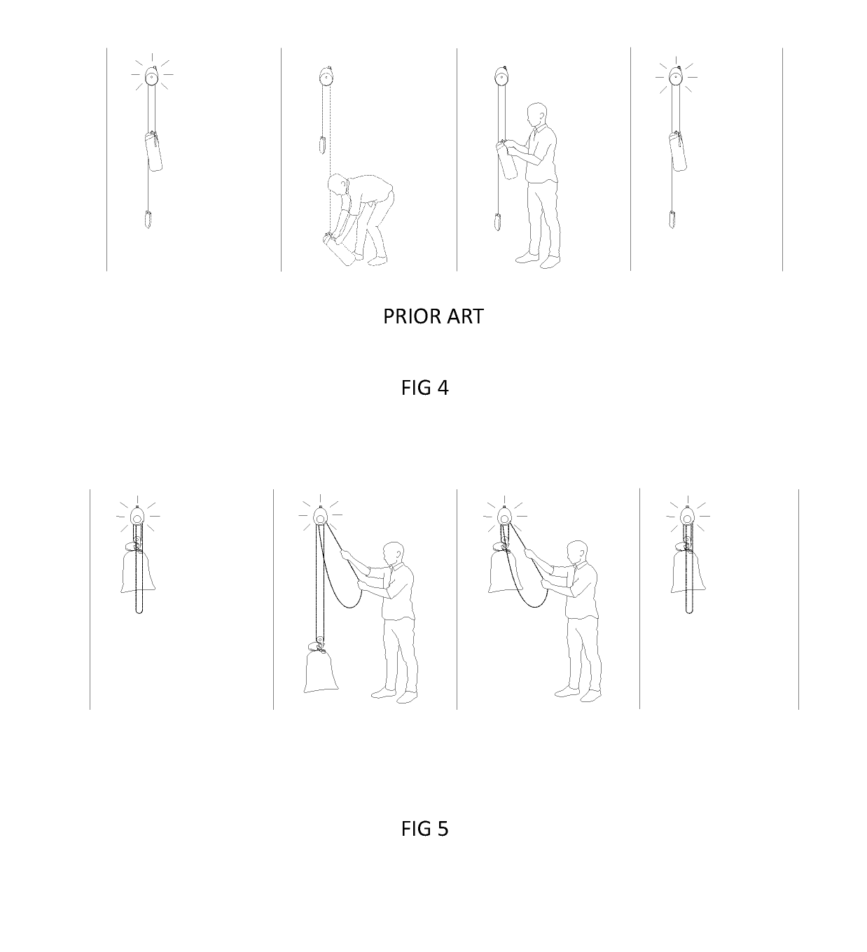

FIG. 4 shows the operation of the prior art GravityLight™ apparatus. A mass and a counter mass are suspended from a belt which passes through the apparatus (shown at the top of each image). Initially, in its charged state (as shown by the image on the far left) the mass is high and slowly descends under the force of gravity, causing the apparatus to generate electricity, which can be converted to light. Once the mass has reached the ground (or if the length of the belt has been exhausted) the mass will cease to descend and so no more electricity or light will be generated by the apparatus. The user then has to lift the mass either directly through grasping it, or by pulling on the counterweight, in the dark with no power being generated by the apparatus in order to charge the system (as shown by the central images). The mass then can once again be released for a fresh bout of electrical generation (as shown by the image on the far right). FIG. 5 shows the equivalent stages in operating an example of the invention for comparison with FIG. 4. Whilst no power will be generated by the apparatus if the mass has reached the ground, the central images illustrate that power will be generated (and may be output in the form of light) from the first moment the user begins to hoist the mass from the ground (unlike the prior art) and that the power and/or light will be uninterrupted should more charge input be given by the user at any point during a drop cycle (unlike the prior art).

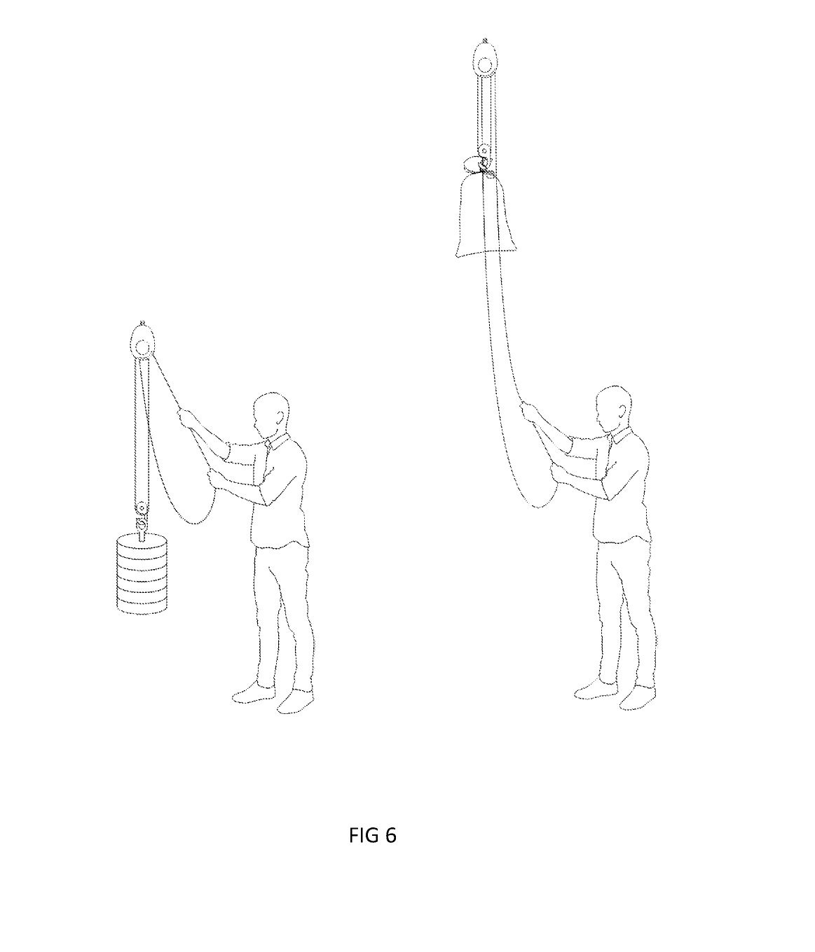

Two further examples of the apparatus in use are shown by FIG. 6. On the left hand side there is an illustration of how examples of the present invention not only allow for continuous running of the electrical generator but also advantageously allow for a heavier mass to be used (by sharing the load between two components and by providing a re-energising mechanism adapted to provide a mechanical advantage so that the force needed to lift the mass is less than half the weight of the mass). On the right hand side of FIG. 6 a further advantage of the invention is illustrated. In this case a long weight chain and a long re-energising member in the form of a loop is provided to enable the mass to be lifted higher, beyond the normal vertical reach of the user. This loop is preferably closed (such as the hoisting chain 29) in order to maintain a fixed length regardless of the height of the mass. Both of the examples shown in FIG. 6 allow the apparatus to operate for longer periods without needing re-energising or to generate higher levels of power for the same period.

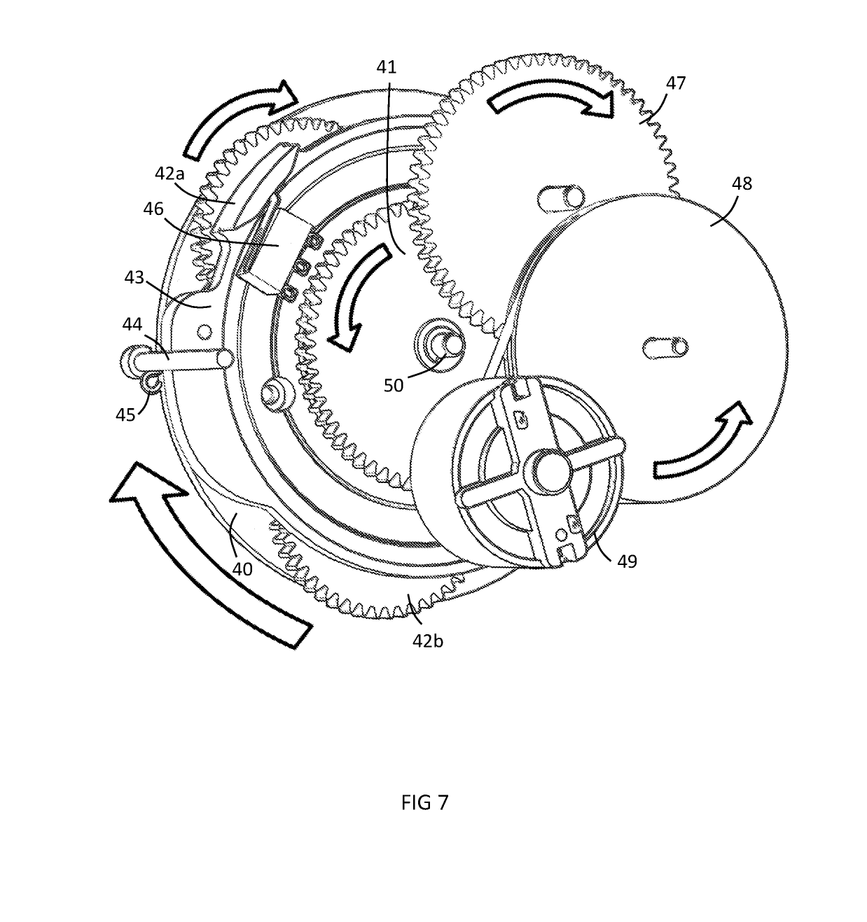

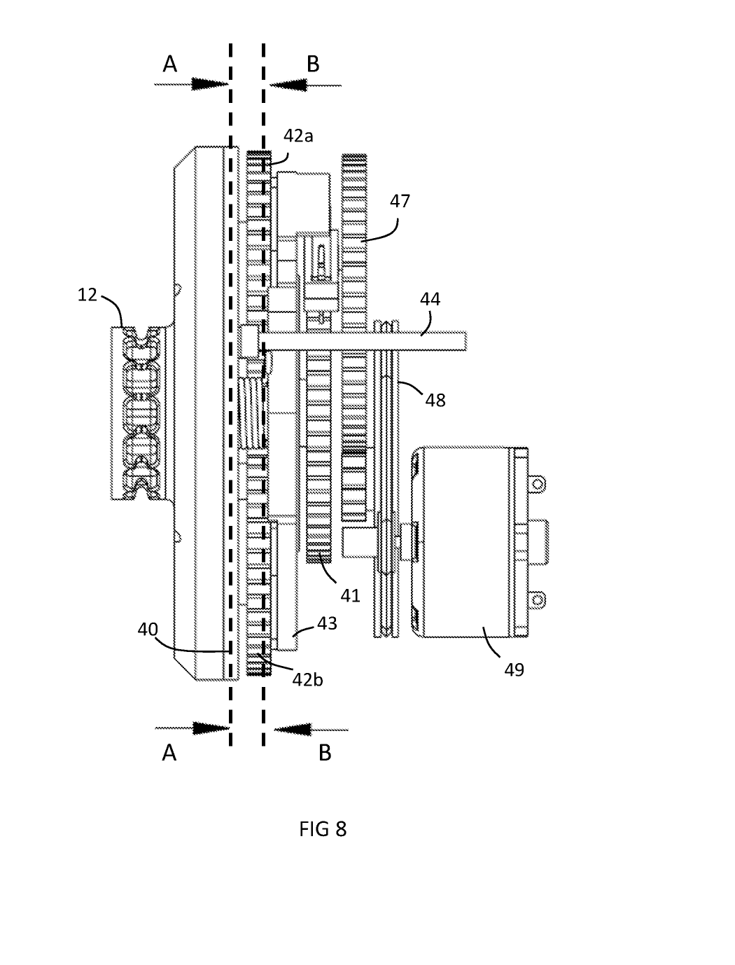

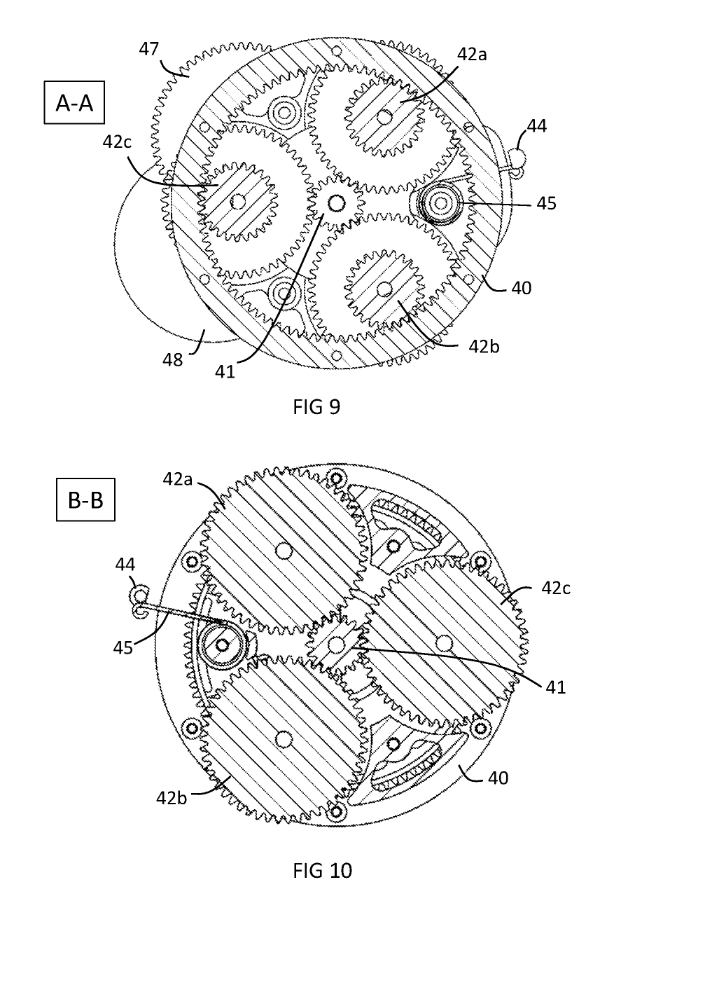

FIG. 7 shows a front view of a gearing system comprising gears associated with the gravity powered drive, together with a gear train of the electrical energy-generating device. A corresponding side view is shown in FIG. 8. The curved arrows in FIG. 7 show the direction of rotation for the gears during normal use, wherein input mechanical action supplied by a controlled, steadily descending mass 7, is converted to electrical energy. A mass 7 is coupled to a sprocket 12, as per the previous examples. The sprocket 12 is fixed to an annulus 40 of the gravity powered drive so that torque may be transmitted from the sprocket 12 onto the annulus 40, causing it to rotate in a clockwise direction shown in FIG. 7. The annulus 40 is configured to drive three planetary gears 42a, 42b, 42c, which also form part of the gravity powered drive, and which engage with a central sun gear 41 of the electrical energy-generating device. The engagement between the planetary gears 42a-42c, the annulus 40 and the sun gear 41 is shown by FIGS. 9 and 10. FIG. 9 illustrates a cross-sectional back view of the gearing system along the A-A plane of FIG. 8 (through the annulus 40), whilst a corresponding front view through the B-B plane (through the planetary gears) is shown by FIG. 10. The planetary gears 42a-42c and the sun gear 41 each have a large toothed circumference on a respective front face and a smaller toothed circumference on a respective back face. This configuration is also known as a ‘compound gear’ comprising a ‘gear’ and a ‘pinion’, wherein the large circumference on the front face forms a gear and the smaller circumference on the back face forms a pinion. Teeth provided on the inside of the annulus 40 are configured to mesh with the teeth provided on the back face of the planetary gears 42a-42c, whilst the teeth of the front face of the planetary gears 42a-42c mesh with those of the back face of the sun gear 41 so as to achieve a high step up interaction between each gear. The planetary gear 42a-42c are each rotatably mounted on respective axes to a mount plate (or ‘planet carrier’) 43, which is itself rotatably mounted to the central shaft 50 and which also forms part of the gravity powered drive. The sun gear 41 is rotatably mounted to a central shaft 50 that forms part of the housing 1.

A flexible (or ‘biased’) member, in the form of a coil spring 45, is integrated within the mount plate 43 such that only a ringed tip of the coil 45 protrudes radially outside of the mount plate 43 and engages with a stop post 44 that forms part of the housing 1. Alternatively, the spring 45 may be fixed to the housing and configured to compress against a protruding feature of the mount plate 43. Either a torsion or a compression spring are well suited to the application dependant on available space. The spring 45 may be preloaded or mounted in its free position as both methods provide the same functional outcome but with slightly altered parameters that depend on the particular embodiment. When mounted in its free position a certain amount of mount plate 43 rotation may be predicted and expected per unit force input to one side of the drive sprocket 12. Alternatively the spring 45 can be preloaded with a tension sufficient to provide a biasing force equivalent to that needed to counteract the torque corresponding to a predetermined safe operating weight of the suspended mass 7 so as to hold the mount plate 43 fixed (rotationally) relative to the housing during normal use when a torque applied to the gravity drive does not exceed a first torque threshold (equivalent to the safe operating weight). The spring 45 is configured to deflect when the torque exceeds this threshold so as to allow the mount plate 43 to rotate, either partially or fully (depending upon the magnitude of the torque), about the central shaft 50. During normal use (i.e. when the mount plate 43 is stationary and before the torque sensing spring 45 has been overcome allowing the mount-plate to freely rotate) the torque supplied to the planetary gears 42a-42c causes them to rotate on their axes and further turn the sun gear 41 in a counter clockwise direction. The apparatus may be typically configured to safely hold a mass of up to 12 kilograms from a sprocket 12 with a 20 millimetres diameter and thus the first torque threshold in that case would be 0.59 Nm The spring 45 and the stop post 44 form part of a torque overload protection mechanism (to be described), which is optional. In alternative embodiments where no such torque overload protection mechanism is provided, the mount plate 43 may instead be fixed to the housing 1 and prevented from rotating.

A penultimate gear 47 and a final gear 48 are provided at the downstream end of the gearing system. Similarly to the planetary gears 42a-42c and the sun gear 41, the penultimate gear 47 and the final gear 48 also each have a front face having a large diameter and a corresponding back face that has a smaller diameter. The toothed back face of the penultimate gear 47 is engaged with the toothed front face of the sun gear 41, whereas the toothed front face of the penultimate gear 47 is engaged with the toothed back face of the final gear 48. Whilst gear teeth ensure a reliable connection and transmission of torque, it is not strictly necessary to provide each of the gears with gear teeth, as toothless gear wheels having a smooth circumference that transmit torque by means of frictional contact may instead be used to facilitate this interaction in some cases. For example, the final gear 48 comprises a smooth outer circumference around its front face (provided as a groove, shown in FIG. 8) which is coupled to the shaft of the generator 49 via a pulley arrangement using a belt (located in the groove). It is advantageous to use a belt for this final coupling, at the fast end of the gearing assembly, since it achieves a reduction in the noise generated by rotation (compared with a toothed contact) and is very low cost and reliable. In some cases the generator shaft may be provided as a conical member so as to enable the user to modify the final step-up interaction, for example by twisting a knob on the outside of the housing so as to adjust the point of contact between the final gear and the conical member, thus changing the power output by the generator. In this case the step-up ratio is fixed however and the resulting gearing ratio along the gearing assembly (from the annulus 40 through to the generator 49) amounts to approximately 1:850. This value can vary widely however to suit the motor's velocity constant (Kᵥ) and the required output voltage (voltage being directly proportional to rotational velocity, and every generator having its unique volts/rpm ratio). It is preferable to use a generator with a high volts/rpm ratio as this reduces the size of the gear ratio required, which reduces the number of gear stages (each of which having an associated efficiency loss) and/or the diameter of the gear wheels. This leads to a more power efficient device and can provide a longer service life.

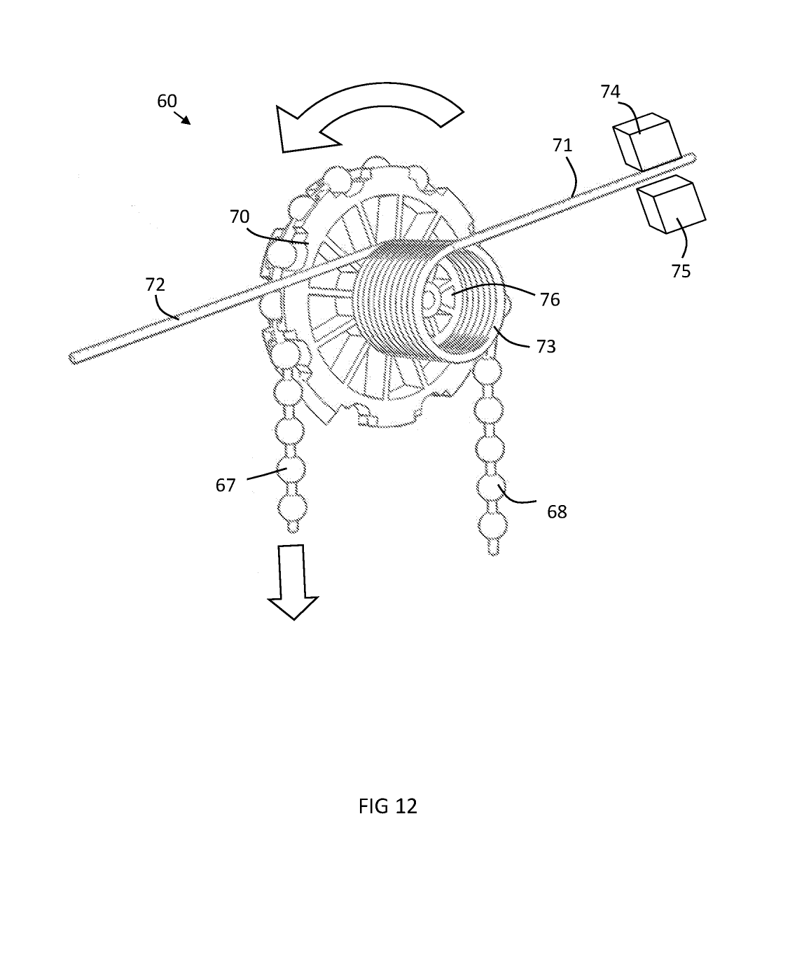

In this example, the apparatus is configured to safely suspend a mass 7 of up to approximately 12 kilograms. If the weight 7 applied to the system exceeds this limit there is a danger that damage may be imparted to the system, in particular to the slow, high torque end of the gear train, or gravity powered drive (e.g. by stripping the gear teeth from the gears) under the excessive torque that arises. It is therefore advantageous to provide an overload protection mechanism that may alert the user that the weight applied to the system is too heavy, and may further protect the gear train from damage in the event of a torque being applied that is in excess of a predetermined threshold. The applicant's prior art WO2014/195681 attempts to provide this by adjusting the load on the generator if the weight applied to the apparatus, as experienced at the hanging point or eyelet of the housing, is in excess of a predetermined threshold. Whilst this method is suitable for use in prior art versions of the GravityLight™, it is less compatible with the continuous version described herein since the mass 7 is no longer raised by a user grasping and lifting the mass 7, but is now instead raised by a user pulling down on a ‘pull’ or ‘hoisting’ chain 8, 18, 29. Depending on the downward force applied by the user (which is unknown), this could cause the overload protection mechanism of the prior art to trigger even when the mass 7 was within the safe threshold (since the trigger is set by the load weight plus the pull force applied by the user). New and improved overload protection mechanisms will now be described which overcome this problem by operating in accordance with the torque applied to the gearing assembly by the suspended mass 7, rather than the total downward force applied to the apparatus at the hanging point by the user and the weight of the mass 7. A torque sensing mechanism and torque overload protection mechanism will firstly be discussed with respect to FIGS. 7 to 11, whilst a wrap torque sensor and a wrap overload protector will later be discussed with respect to FIGS. 12 to 16.

Referring to FIGS. 7 to 11, a switch 46 is mounted to the housing and is mechanically biased to engage with a curved feature 51 on the mount plate 43 which is radially thickest in the centre and is tapered in each circumferential direction of rotation towards the edges. The switch 46 is closed during normal use, wherein the mount plate 43 is held fixed relative to the housing (as previously described). As the weight of the suspended mass 7 is increased (e.g. by filling the bag 7 with more soil), the torque applied to the gravity powered drive also increases until a first torque overload condition is met in excess of a first torque threshold (for example between 75% and 95% of the ‘rated’ or ‘design’ torque, wherein the apparatus may typically achieve the required service life without system failure). At this point, the resistance provided by the spring 45 is partially overcome so as to cause the mount plate 43 to partially rotate relative to the housing and post 44, e.g. by 1-20 degrees. In the first torque overload condition, the end of the spring 45 is compressed and deflected backwards but still engages with the post 44 so as to prevent full (i.e. free) rotation of the mount plate 43. The rotational movement of the mount plate 43 relative to the housing is however sensed by the switch 46 acting against the curved feature 51 of the mount plate 43, causing it to open as the distance between the surface of the curved feature 51 and the switch increases. This initiates a change of state in the switch, for example by outputting a signal, or by re-routing power through another component(s), to indicate that the first torque overload condition has been met. This change of state may trigger a warning device, such as a buzzer or a red LED, to alert the user that the weight of the bag 7 is dangerously high.

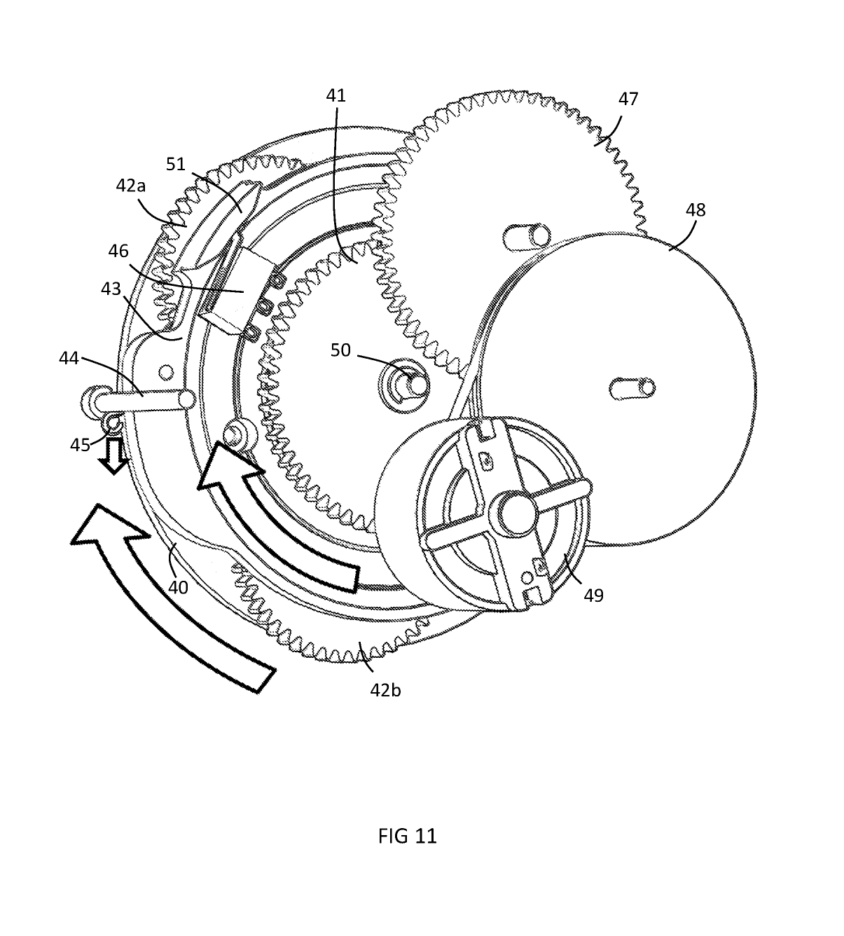

If the user continues to increase the weight of the suspended mass 7, or if a sudden large increase in weight with respect to the normal loading condition occurs, a second torque threshold may be reached in excess of the first torque threshold wherein the spring 45 is entirely deflected past the post 44 and full rotation of the mount plate 43 is thus permitted. The spring 45 may be carried with the rotating mount plate 43 in this case as it is no longer compressed against the stop post 44 and the mount plate 43. This second torque overload is shown in FIG. 11.

During the second torque overload condition, the planetary gears 42a-42c, which are rotatably mounted to the mount plate 43, no longer spin on their axes and instead now rotate with the annulus 40 about the sun gear 41. As the planetary gears 42a-42c are now orbiting the sun gear 41, no torque (or rotation) is imparted onto the electrical energy-generating device (formed from gears of 41, 47, 48 and the generator 49). In this event, the gravity powered drive (comprising gears 40, 43 and 42a-42c) is effectively decoupled from the electrical energy-generating device so as to protect the gravity powered drive and weight chain from any damage that could result from the high torque.

The power provided by the generator 49 will hence cut out during the second torque overload condition and the suspended mass 7 will accelerate towards the ground. Each time the mount plate 43 completes a full 360 degree rotation, the spring 45 will however once again be brought into contact with the stop post 44, causing a sudden deceleration of the falling mass 7. Provided that the torque applied to the mount plate 43 at this point is still in excess of the second torque threshold, the spring 45 will once again be deflected past the post 44.

A further advantage of the torque overload protection mechanism described herein is that in configurations where the mount plate is to remain static until an excessive mass is applied, a more lightweight spring (in contrast to the prior art) can be fitted which does not have to be preloaded to a bias to account for the weight of the mass 7, plus the weight of the apparatus itself and the downward force applied by a user to hoist the mass. This is beneficial as a lightweight spring 45 will put less strain on the system, is safer to install and is lower cost by virtue of its reduced material mass.

Experience in testing prior art versions of the GravityLight™ device has shown that the clicking noise generated by ratchet when lifting the mass is often considered a nuisance to users. In a further embodiment of the invention, this noise is removed by replacing the re-wind sprocket 11 and pawl 15 of the re-energising mechanism with a wrap clutch 60. As well as reducing the noise generated by the device, this also leads to a reduction in the cost of the overall assembly and allows further possibilities for preventing damage being inflicted to the apparatus due to an overly heavy mass being hoisted.

Examples of re-energising mechanisms comprising a wrap clutch 60 are shown by FIGS. 12 to 16. As discussed above, this wrap clutch 60 may be provided in place of the ratchet mechanism comprising the sprocket 11, 21 and pawl 15, 25 shown in FIGS. 2 and 3. These wrap clutch examples below are otherwise fully compatible with each of the earlier examples of the apparatus discussed.

The wrap clutch 60 comprises a rewind sprocket 70 that is configured to engage with a beaded chain 67, 68 which forms the elongate flexible member of the gravity powered drive. A loaded portion 67 (equivalent to 16a in FIG. 2) of the chain extends between the rewind sprocket 70 and a suspended mass 17 and provides a downward force on the re-wind sprocket 70 (shown by the downward arrow) which is equal to half of the weight of the suspended mass. An unloaded portion 68 of chain (equivalent to 18a) hangs freely from the other end of the re-wind sprocket 70. The unloaded portion 68 forms part of the second loop 18 of the elongate flexible member and may be pulled downward during a re-energising procedure.

A mandrel 76, in the form of a cylindrical hub, extends from the centre of the re-wind sprocket 70 about a common rotational axis. A coil spring 73 is wound tightly around the circumference of the mandrel 76 (in a first direction shown here as anti-clockwise and towards the re-wind sprocket 70) so as to grip the mandrel 76. The coil spring 73 comprises two opposing projections or ends, referred to as the first tang 71 and the second tang 72, which extend tangentially from the mandrel 76. The first tang 71 extends between a stop block 74 and a first release block 75 (schematically illustrated). The stop block 74 is positioned so as to prevent rotation of the first tang 71 in the first direction beyond a predetermined amount, whereas the first release block 75 is positioned so as to prevent rotation of the first tang 71 in a second direction, opposite to the first direction, by a predetermined amount.

During normal use, when the suspended mass 17 is steadily descending and powering the apparatus, the loaded portion 67 provides a torque acting in the first direction onto the re-wind sprocket 70 and the mandrel 76. This torque is then transferred to the coil spring 73, causing the first tang 71 to come into contact with the stop block 74. This abutment provides a resistive force in the second direction, opposite to the first direction, which causes the coil spring 73 to further tighten and furthermore holds the mandrel 76 in a fixed position, preventing any rotation of the rewind sprocket 70. This has the effect of preventing the re-energising mechanism from slipping, allowing the mass 17 to remain suspended and transfer mechanical action to the gravity powered drive. This is the case so long as the torque applied to the rewind sprocket 70 by the suspended mass is within a predetermined operational range.

FIGS. 13 to 16 schematically illustrate a further embodiment which is identical to the previous embodiment of FIG. 12 except that a wrap torque sensor and a wrap overload protector are also provided. In alternative embodiments either the wrap torque sensor or the wrap overload protector may be provided separately. The wrap torque sensor comprises a sensor 80 and a warning device (not shown), such as a red LED or a buzzer. The sensor 80 is configured to provide an electrical change of state, such as a signal, in response to a displacement of the coil spring 73 beyond a predetermined threshold. This predetermined movement occurs at a first wrap overload condition, when the torque applied to the re-wind sprocket 70 exceeds a predetermined threshold referred to as the first wrap torque threshold. The warning device is electrically coupled with the switch 80 and configured to alert the user to the presence of the first wrap torque overload condition in response to said electrical change of state.

The wrap overload protector comprises a release block 79 which is configured to engage with the end of the second tang 72 when the torque applied to the re-wind sprocket 70 exceeds a predetermined threshold referred to as the second wrap torque threshold; said second wrap torque threshold being greater than said first wrap torque threshold.

FIG. 13 illustrates the wrap clutch during a re-energising procedure wherein a user pulls down on the unloaded portion 68 of the pull chain 18 so as to rotate the rewind sprocket 70 about a second direction, illustrated by the curved arrow. The motion of the rewind sprocket 70 drives the mandrel 76, and with it the coil spring 73 which is firmly wrapped around the mandrel 76, to also rotate in the second direction until the first tang 71 connects with the first release block 75. The first release block 75 will then apply a resistive force in the first direction which prevents the first tang 71 from rotating further and which opens the coil 73 causing a reduction in the gripping force applied to the mandrel 76 by the coil spring 73. For a sufficient pull force, the coil spring will loosen sufficiently to allow the mandrel 76 to rotate inside the coil spring 73 (i.e. relative to the coil spring 73) in the second direction. This enables the loaded portion 67 of the chain, which bears the mass 17 to be raised, meanwhile delivering mechanical input to the gravity powered drive.

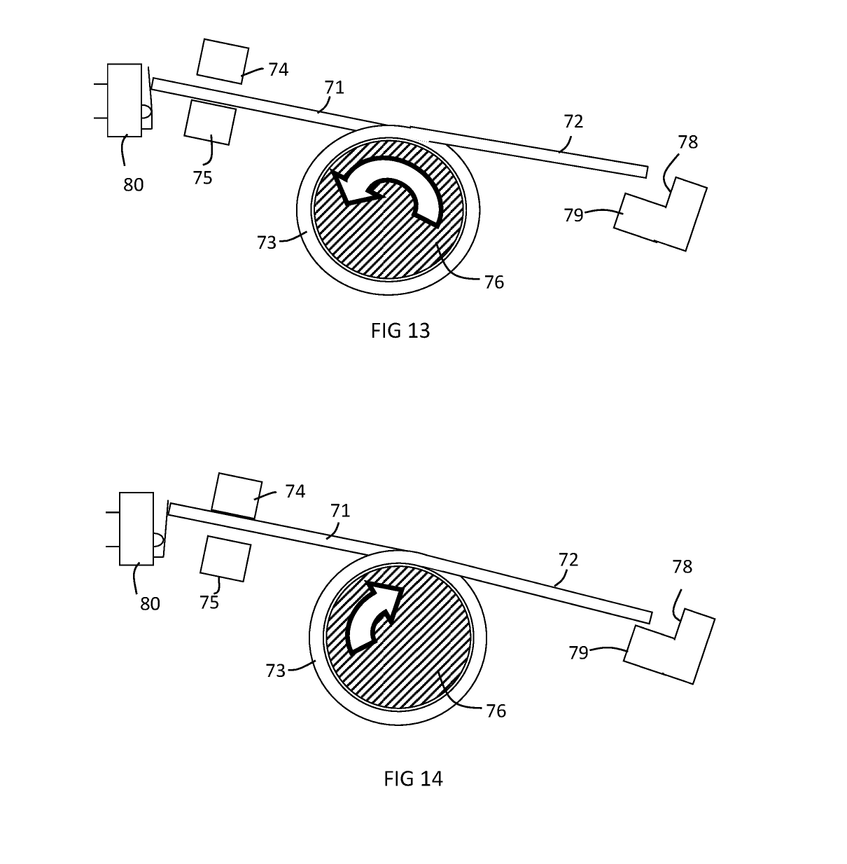

FIG. 14 illustrates the same wrap clutch mechanism when the torque applied by the mass 17 is within the predetermined operational range and below the first wrap torque threshold. The weight applied to the loaded portion 67 of the weight chain 16 causes the mandrel 76 and coil spring 73 to rotate in the first direction and the first tang 71 to come into contact with the stop block 74, as previously discussed. Additional rotation of the coil spring 73 in the first direction causes a displacement of the coil spring in the form of an angular sweep of the second tang 72 through an arc. In this example, the switch 80 comprises a biased member which is urged against the tip of the first tang 71 and configured to transition from a closed position to an open position in response to a shortening of the first tang 71 beyond a predetermined amount. The switch 80 may however be positioned in a number of other positions to monitor displacement of the coil spring 73, as will be appreciated by the skilled person.

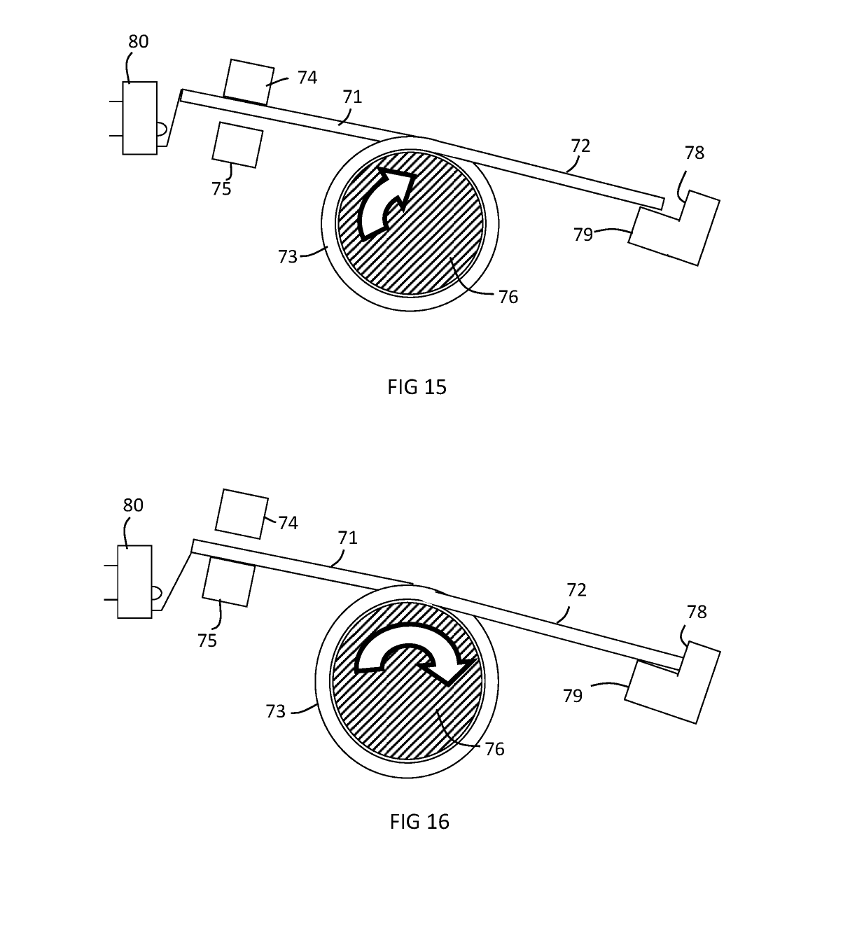

FIG. 15 illustrates the scenario when the weight of the mass 17 is increased until a first wrap overload condition is met, wherein the torque at the rewind sprocket 70 exceeds the first wrap torque threshold but still lies within the predetermined operational range of torque. At this point the first tang 71 has shortened by a sufficient amount to cause the switch 80 to transition from a closed state to an open state. This may cause a warning device to alert the user that the weight 17 is too heavy and should be reduced or damage will be incurred to the apparatus. As the torque still lies within the predetermined operational range of torque, the coil spring 73 continues to apply a sufficient gripping force to the mandrel 76 that prevents rotation of the rewind sprocket 70 in the second direction.

The second stop block 79 of the wrap overload protector here forms an L shape and comprises a stopping surface 78. As the torque applied to the re-wind sprocket 70 in the first direction is increased, the second tang 72 continues to rotate in the first direction, which brings it into contact with the second stop block 79 until the tip of the second tang eventually abuts onto the stopping surface 78, preventing the second tang 72 from rotating further in the first direction. If the torque further increased beyond the operational range of torque and hence beyond the second wrap torque threshold (said second wrap torque threshold forming the upper limit of the operational range), a second wrap overload condition is met. This is shown by FIG. 16. At this point the resistive force provided by the stopping surface 78 onto the second tang 72 prevents the coil spring 73 from the further tightening of its grip on the mandrel 76 such that the internal resistance provided between the outside of the mandrel 76 and the inside of the coil spring 73 is overcome. The mandrel 76 and the rewind sprocket 70 are then able to rotate in the second direction causing a controlled accelerated descent of the suspended mass 17 towards the floor, thus protecting the apparatus from damage due to an excessively heavy weight being suspended. This damage could occur to the gears or the elongate flexible member, as previously described, or at the wrap clutch itself, for example by plastic deformation of the first or second tang 71, 72.

This descent is controlled in the sense that although the mandrel 76 now turns inside the coil spring 73, some internal resistance remains which causes a braking force that prevents the mass from otherwise free-falling. Uncontrolled descents can give the impression to the user that the apparatus has permanently broken (where in fact this may not be the case if a torque overload protection mechanism is provided, for example). The wrap torque overload protector thus provides the added advantage that this impression avoided, by instead enabling a relatively slower, controlled descent.

The first wrap torque threshold and the second wrap torque threshold may typically be set to similar levels to the first overload threshold and the second overload threshold respectively. For example, the wrap torque sensor may protect against general wear of the apparatus due to slightly too much weight being applied over a prolonged period, whereas the wrap overload protector may protect against the risk of sudden failure due to overload. This can be achieved by choosing a coil spring 73 with appropriate tensile properties.

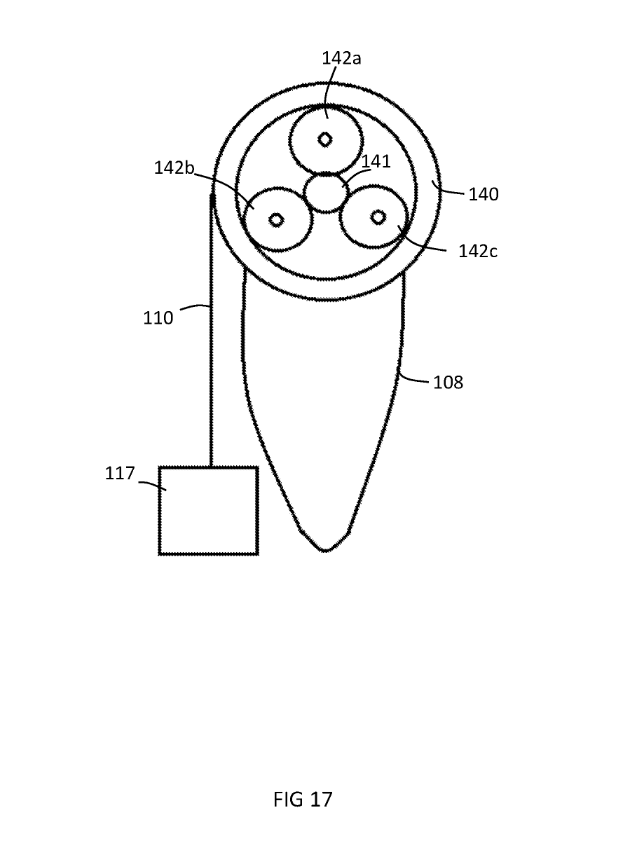

FIG. 17 is a schematic illustration of a further embodiment that enables the apparatus to be recharged (re-energised) via a different arrangement. The apparatus comprises a gear system similar to that of FIGS. 7 to 11. Only parts of this are shown for clarity however. In this example the mass 117, rather than being suspended from a closed loop, is attached to the end of an open ended length of elongate flexible member, referred to as the weight chain 110. The weight chain 110 is coupled to a sprocket that is fixed to the annulus 140 so as to drive the annulus 140 to rotate in a first direction in response to the weight of the suspended mass 117. In FIG. 17 the weight chain 110 is schematically shown as being coupled to the outside of the annulus 140. The opposing end of the weight chain 110 (not attached to the mass 117) may trail freely from an exit hole of the apparatus, or be wound around a lightly sprung or mechanically coupled storage drum inside the apparatus.

A plurality of planetary gears, in this case three, 142a, 142b, 142c are provided within the annulus 140 and configured to rotate on their respective axes in the first direction in response to a rotation of the annulus 140 in the first direction. The rotating planetary gears 142a-142c are then configured to drive a central sun gear 141 to rotate in a second direction, wherein the second direction is opposite to the first direction, which in turn provides a mechanical input to an electrical generator via a series of high step up ratio gears (not shown). The planetary gears 142a-142c are mounted to a mount plate (not shown) which is coupled to a re-energising member 108. In this example the re-energising member 108 is a closed loop of elongate flexible member referred to as the ‘pull cord’ which is coupled directly to the mount plate via a sprocket. Alternatively the pull cord 108 may be coupled to the mount plate via one or more intermediate gears configured to provide a mechanical advantage during a re-energising procedure.

The mount plate is rotatable in a second direction only. This is achieved via a ratchet or a wrap clutch, for example. This rotation occurs during a re-energising procedure only, whereby a user pulls down on the pull cord 108 to apply a reverse torque to the mount plate, causing it to rotate in the second direction. This causes the planetary gears 142a-142c to now orbit the sun gear 141 in the second direction (where previously the planetary gears were stationary with respect to the sun gear), whilst still spinning on their respective axes in the first direction. This drives the annulus 140 to rotate in the second direction also, thereby retracting/winding the weight chain 110 up and lifting the mass 117. Continuous power to the electrical energy-generating device is maintained throughout however. The weight chain 110 continues to apply a force on the annulus 140 that causes it to drive the planetary gears 142a-142c to rotate on their axes, despite the fact that the net movement of the annulus 140 is in the second direction. The rotation of the planetary gears 142a-142c about their axes of rotation in the first direction continues throughout and is what drives the sun gear 141 and the remainder of the electrical-energy generating device.

This example is compatible with the overload protection mechanisms and sensors previously described. For example, the mount plate may be configured to rotate in the first direction only due to the presence of a wrap clutch, which may be provided with a wrap torque overload protector and/or wrap torque sensor.

Various advantages are also achieved using the above arrangement. For example, the ability to suspend the mass 117 from an open ended length of elongate flexible member 110, as opposed to a closed loop, reduces the length of elongate flexible member required; leading to cost reductions. Furthermore the hook (which suspends the weight bag) does not need be configured to allow the weight chain 110 to move through it (e.g. by providing of a wheel or a sprocket on the hook). This further reduces the cost, removes a potential point of failure and eliminates a heavily loaded shaft thereby increasing the overall efficiency.

As will be appreciated from the various embodiments described above an improved portable apparatus for generating electrical energy is provided that offers significant benefits to the user compared with previous versions of the device.

1. A portable apparatus for generating electrical energy, the apparatus comprising:
an electrical energy-generating device for generating electricity in response to input mechanical action;
a gravity powered drive for supplying the said mechanical action to the electricity-generating device by the descent of a suspended mass under the force of gravity; and
a re-energising mechanism adapted to enable the gravity powered drive to operate whilst the mass is being raised.

2. A portable apparatus according to claim 1, wherein the re-energising mechanism enables the gravity powered drive to be subjected to the gravitational force of the mass whilst the mass is being elevated during a re-energising procedure.

3. A portable apparatus according to claim 1, wherein the gravity powered drive comprises a drive mechanism and an elongate flexible member, wherein said elongate flexible member is coupled with the drive mechanism and the mass when in use so as to provide the gravitational force for operation.

4. A portable apparatus according to claim 3, wherein the elongate flexible member is a sprocket belt, a chain, a strap or a cord.

5. A portable apparatus according to claim 3, wherein the elongate flexible member is further coupled with the re-energising mechanism.

6. A portable apparatus according to claim 5, wherein each of the re-energising mechanism and the drive mechanism are coupled in series simultaneously at different locations along the elongate flexible member.

7. A portable apparatus according to claim 6, further adapted such that, wherein during a re-energising procedure, the length of elongate flexible member between the said different locations is changed.

8. A portable apparatus according to claim 6, further adapted such that, wherein during a re-energising procedure, part of the said length of the elongate flexible member is grasped by a user and a force applied to the elongate flexible member so as to change the said length and lift the mass.

9. A portable apparatus according to claim 3, wherein the elongate flexible member is provided as a closed endless loop.

10. A portable apparatus according to claim 9, wherein said elongate flexible member forms a first loop and a second loop, said mass being suspended from the first loop only, wherein said mass is raised by pulling on the second loop so as to increase the length of said second loop and decrease the length of the first loop.

11. A portable apparatus according to claim 1, wherein the re-energising mechanism is arranged to provide a mechanical advantage with respect to the force provided by the descending mass such that the force needed to lift the mass is less than the gravitational force provided by the mass.

12. A portable apparatus according to claim 1, wherein the re-energising mechanism is provided with a re-energising member in the form of an elongate flexible member.

13. A portable apparatus according to claim 12, wherein the re-energising member is provided as a sprocket belt, a chain, a strap or a cord.

14. A portable apparatus according to claim 13, wherein the re-energising member is provided as a recoil member or as an endless loop.

15. A portable apparatus according to claim 1, wherein the re-energising mechanism comprises a ratcheted sprocket.

16. A portable apparatus according to claim 1, wherein the re-energising mechanism comprises a wrap clutch, said wrap clutch comprising:
a rewind sprocket having a central mandrel that is coaxial therewith; and
a coil spring, that is wound about the mandrel;
wherein said coil spring is configured to apply a gripping force to the mandrel when a torque, having a magnitude within a predetermined operational range of torque, is applied to the rewind sprocket in a first direction, the said gripping force being sufficient to prevent rotation of the rewind sprocket in said first direction; and
wherein said coil spring is further configured to be decoupled from the mandrel, during a re-energising procedure, when a torque is applied to the rewind sprocket in a second direction opposite to the first direction, so as to allow rotation of the rewind sprocket in the second direction.

17. A portable apparatus according to claim 16, wherein a first part of the coil spring is configured to be displaced by a predetermined amount in accordance with a first wrap overload condition in which the torque applied to the rewind sprocket in the first direction lies within the said predetermined operational range and exceeds a first wrap torque threshold;
wherein said wrap clutch further comprises a wrap torque sensor in the form of a first switch; and
wherein said first switch is operative to provide an electrical change of state in response to said displacement of the first part of the coil spring when the first wrap overload condition has been met.

18. A portable apparatus according to claim 17, wherein the wrap torque sensor further comprises a warning device configured to indicate to a user when the first wrap overload condition has been met in response to the electrical change of state provided by the first switch.

19. A portable apparatus according to claim 1, wherein said wrap clutch comprises a wrap overload protector operatively configured to prevent the gripping force from exceeding a predetermined magnitude, said predetermined magnitude of gripping force corresponding to an upper limit of said operational range or torque according to a second wrap overload condition, wherein when the torque applied to the rewind sprocket in the first direction exceeds the upper limit of the operational range of torque, the mandrel is allowed to rotate relative to the coil spring thereby causing a controlled descent of the mass.

20. A portable apparatus according to claim 19, wherein said wrap overload protector includes a projection from the coil spring and a stop, the projection being adapted to impact against the stop due to rotation of mandrel, whereby the stop prevents the gripping force from exceeding the predetermined magnitude.

21. A portable apparatus according to claim 1, further comprising a slip clutch adapted to prevent the mass from being raised when the re-energising mechanism is subjected to a hoisting force in excess of a predetermined threshold.

22. A portable apparatus according to claim 1, wherein the apparatus is configured such that the gravity powered drive and electrical energy-generating device may rotate at least partially with respect to each other about a common axis, the apparatus further comprising a torque sensing mechanism, wherein said torque sensing mechanism comprises:
a flexible member configured to resist relative rotation between the gravity powered drive and the electrical energy-generating device, wherein the flexible member prevents any said rotation if a torque applied to the gravity powered drive is below a first torque threshold and, wherein at a first torque overload condition, where the torque applied to the gravity powered drive exceeds the first torque threshold, the resistance provided by the flexible member is partially overcome so as to allow partial rotation between the gravity powered drive and the electrical energy-generating device; and
a second switch operative to provide an electrical change of state when the first torque overload condition has been met, in response to said partial rotation.

23. A portable apparatus according to claim 22, further comprising a warning device configured to indicate to a user when the first torque overload condition has been met in response to the electrical change of state provided by the second switch.

24. A portable apparatus according to claim 1, wherein the apparatus is configured such that the gravity powered drive and electrical energy-generating device may rotate with respect to each other about a common axis, the apparatus further comprising a torque overload protection mechanism;
wherein said torque overload protection mechanism is configured to allow full rotation between the gravity powered drive and the electrical energy-generating device only if the gravity powered drive is subjected to a torque in excess of a second torque threshold according to a second torque overload condition.

25. A portable apparatus according to claim 22, wherein the apparatus is configured such that the gravity powered drive and electrical energy-generating device may rotate with respect to each other about a common axis, the apparatus further comprising a torque overload protection mechanism;
wherein said torque overload protection mechanism is configured to allow full rotation between the gravity powered drive and the electrical energy-generating device only if the gravity powered drive is subjected to a torque in excess of a second torque threshold according to a second torque overload condition;
wherein the torque corresponding to the second torque threshold is in excess of the torque corresponding to the first torque threshold.

26. A portable apparatus according claim 24, wherein said torque overload protection mechanism is configured to decouple the gravity powered drive from the electrical energy-generating device during the second torque overload condition, so as to allow the mass to descend without providing input mechanical action to the electrical energy-generating device.

27. A portable apparatus according to claim 1, wherein said gravity powered drive comprises an annular gear, a plurality of planetary gears and a mount plate, wherein said planetary gears are mounted to the mount plate and configured to engage with the annular gear; wherein said electrical energy-generating device comprises a gear train having a sun gear positioned at an upstream end of the gear train and an electrical generator positioned at a downstream end of the gear train, wherein the sun gear is configured to engage with the planetary gears.

28. A portable apparatus according claim 22, wherein said gravity powered drive comprises an annular gear, a plurality of planetary gears and a mount plate, wherein said planetary gears are mounted to the mount plate and configured to engage with the annular gear; wherein said electrical energy-generating device comprises a near train having a sun gear positioned at an upstream end of the gear train and an electrical generator positioned at a downstream end of the gear train, wherein the sun gear is configured to engage with the planetary gears;
wherein said rotation between the gravity powered drive and the electrical energy-generating device is effected by the mount plate being configured to rotate about the sun gear.

29. A portable apparatus according to claim 27, wherein:
the annular gear is configured to rotate in a first direction when the gravity powered drive is driven by the suspended mass;
the re-energising mechanism is configured to prevent rotation of the mount plate in the first direction and to allow rotation of the mount plate in a second direction opposite to the first direction in response to a mechanical input provided by a user during a re-energising procedure; and
said rotation of the mount plate in the second direction causes the annular gear to rotate in the second direction, thereby raising the mass.

30. A portable apparatus according to claim 22, wherein the apparatus is configured such that the gravity powered drive and electrical energy-generating device may rotate with respect to each other about a common axis, the apparatus further comprising a torque overload protection mechanism;
wherein said torque overload protection mechanism is configured to allow full rotation between the gravity powered drive and the electrical energy-generating device only if the gravity powered drive is subjected to a torque in excess of a second torque threshold according to a second torque overload condition
wherein said gravity powered drive comprises an annular gear, a plurality of planetary gears and a mount plate, wherein said planetary gears are mounted to the mount plate and configured to engage with the annular gear; wherein said electrical energy-generating device comprises a gear train having a sun near positioned at an upstream end of the gear train and an electrical generator positioned at a downstream end of the gear train, wherein the sun gear is configured to engage with the planetary gears;
wherein said rotation between the gravity powered drive and the electrical energy-generating device is effected by the mount plate being configured to rotate about the sun gear;
wherein the flexible member is configured to provide a resistance force so as to resist relative rotation between the mount plate and the electrical energy-generating device in response to a torque applied to the mount plate by the planetary gears mounted thereon;
wherein the resistive force provided by the flexible member is such that:
below the first torque threshold applied to the mount plate, the flexible member engages with the mount plate so as to limit rotation of the mount plate relative to the electrical energy-generating device;
above the first torque threshold but below the second torque threshold applied to the mount plate, the flexible member is deflected by the mount plate so as to allow a further rotation of the mount plate about the electrical energy-generating device; and
above the second torque threshold, the flexible member is disengaged so as to allow a free rotation of the mount plate about the electrical energy-generating device.

31. A portable apparatus according to claim 1, wherein the electrical energy-generating device comprises an electrical generator selected from the group comprising an alternator, a direct current motor or a dynamo.

32. A portable apparatus according to claim 1, wherein the electrical energy-generating device comprises a gear train for converting a relatively low speed input from the gravity powered drive to a relatively high speed output at the electrical energy-generating device.

33. A portable apparatus according to claim 1, wherein the electrical energy-generating device and gravity powered drive are provided as a unit, the gravity powered drive including a flexible sprocket belt to one end of which is coupled the mass when in use so as to provide the force for operation of the apparatus.

34. (canceled)
